(19) United States
(12) Patent Application Publication
(10) Pub. No.: US 2018/0222550 A1
(43) Pub. Date: Aug. 9, 2018

(54) THREE-SPEED MOTORCYCLE TRANSMISSION

(71) Applicant: Piaggio & C. S.p.A, Pontedera (PI) (IT)

(72) Inventors: Paolo Nesti, Pontedera (PI) (IT); Walter Mariotti, Pontedera (PI) (IT)

(73) Assignee: Piaggio & C. S.p.A, Pontedera (PI) (IT)

(21) Appl. No.: 15/749,365

(22) PCT Filed: Aug. 1, 2016
(86) PCT No.: PCT/EP2016/068289

§ 371 Date: Jan. 31, 2018

(30) Foreign Application Priority Data
Aug. 3, 2015 (IT) 102015000041517

(51) Int. Cl. B62M 9/10; B62M 11/04; F16D 43/14; F16H 3/12

(52) U.S. Cl. CPC B62M 9/10; B62M 11/04; F16H 2200/0039; F16H 3/12; F16D 43/14

(57) ABSTRACT

A three-speed motorcycle transmission (1), to be used aboard a motorcycle as transmission means for 5 transmitting the motion generated by an engine to a driving wheel, having performances similar to those of a continuously variable transmission but, at the same time, a high efficiency and an easy automatic operation, comprises: a crankshaft (2), which receives the motion by 0 an engine, having a first pulley (9) mounted thereon; a primary shaft (4), having a second pulley (12) and a first set of three gears (21, 22, 23) mounted thereon; a transmission belt (11) connecting said first and said second pulley (9, 12); a secondary shaft (4), connected 5 to a driving wheel, comprising a second set of three gears (31, 32, 33), engaged in pairs with respective gears (21, 22, 23) of the first set of three gears for the transmission of the first, second and third speed; a clutch (10) acting selectively on at least two pairs of 0 gears assigned to the transmission of the second and third speeds; and two free wheels (15, 18) arranged at the pairs of gears assigned to the transmission of the first and second speed.

The present invention has as subject a three-speed synchronous transmission, in particular to be used aboard a motorcycle, such as a scooter, as transmission means for transmitting the motion generated by an engine to a single driving wheel or a double driving wheel, in particular the rear wheel of a motorcycle. In the following, motorcycles and scooters are considered equivalent.

In the scooters of last generation the most commonly used transmission is of the CVT (Continuously variable transmission) type, called continuous transmission or continuous variator.

CVT has the advantage of providing a continuous traction and of not requesting the manual actuation of the different ratios. However, by using means of sliding type, such transmission is characterized by a low efficiency, above all in the transitory manoeuvers when the hysteresis effect of the transmission belt is maximum.

This pushes downwards the general efficiency of the vehicle and increases the consumption thereof.

On the other hand, a much felt requirement in the field is that of limiting the consumption as much as possible, however, if requested by the market, by keeping the comfort level thereto the users have got used by the CVT transmission.

U.S. Pat. No. 4,505,352 A discloses a transmission for motorcycles having pulleys but no free wheel to transmit the motion.

European patent application No. 2,151,602 A1 discloses a stepped transmission for motorcycles using no pulley.

The object underlying the present invention is then to increase significantly the overall efficiency of the transmission in two-wheel or three-wheel motorcycles for the urban transport.

The idea underlying the present invention is to provide a synchronous or nearly synchronous transmission, i.e. possibly including belts but of synchronous or nearly synchronous type, e.g. equipped with suitable teeth for the synchronous transmission of the motion from the pulley to the belt and from the belt to the pulley, wherein the hysteresis effect is reduced to the minimum and therefor the efficiency can be compared to the one which can be obtained with systems of pinion-chain-crown type.

In order to guarantee an adequate range (the value given by the ratio in the highest gear divided by the ratio in the first gear) and which can be compared to the one guaranteed by a traditional CVT system, it is possible providing the use of three speeds.

Therefore, the above-mentioned problem is solved by a three-speed synchronous transmission as specified above, which characterizes in that it comprises:
a crankshaft, which receives the motion by an engine, having a first pulley mounted thereon;
a primary shaft, having a second pulley and a first set of three gears mounted thereon,
a transmission belt connecting said first and said second pulley;
a secondary shaft, connected to a driving wheel, comprising a second set of three gears, engaged in pairs with respective gears of the first set of three gears for the transmission of the first, second and third speed;
a clutch acting selectively on at least two pairs of gears assigned to the transmission of the second and third speeds; and
two free wheels arranged at the pairs of gears assigned to the transmission of the first and second speed.

The main advantage of the three-speed synchronous transmission according to the present invention lies in having performances similar to those of a continuously variable transmission but, at the same time, a high efficiency and an easy automatic operation.

In the light of what above stated, it is possible implementing this synchronous transmission in a simple and compact solution which can be automatized.

The present invention will be described hereinafter according to a preferred embodiment example thereof, provided by way of example and not with limitative purposes by referring to the enclosed drawings wherein:

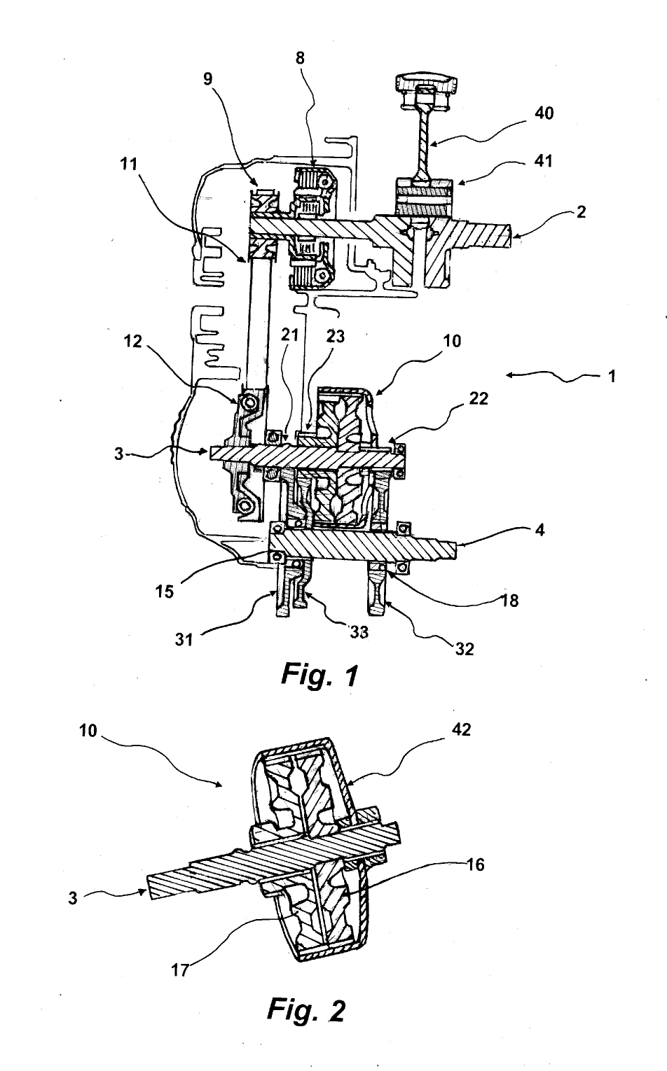

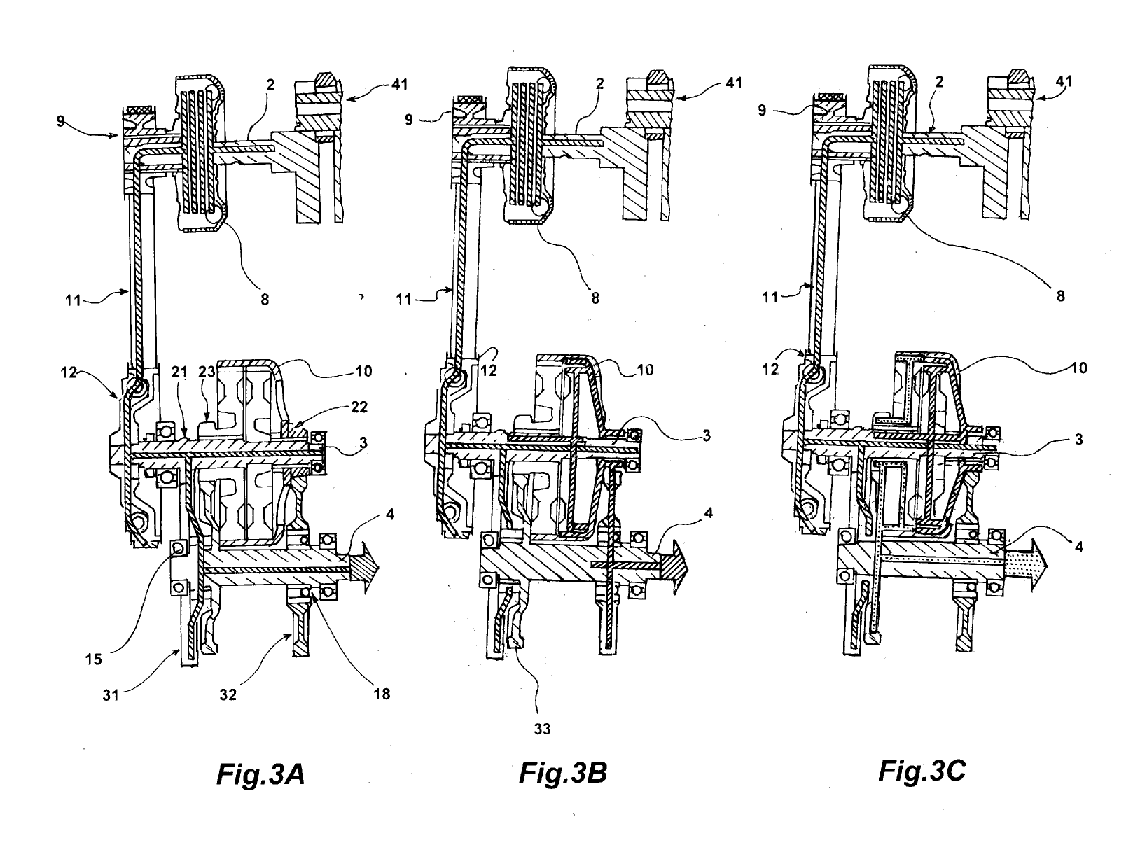

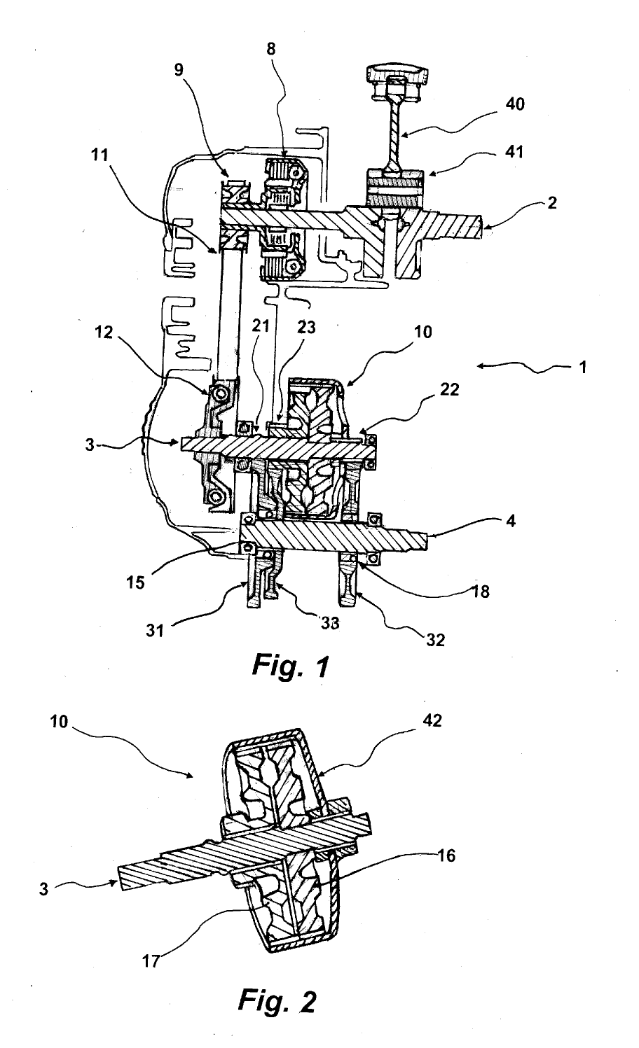

FIG. 1 shows a longitudinal section view of an example of three-speed synchronous transmission according to the invention;

FIG. 2 shows an axonometric view of a detail of the synchronous transmission of FIG. 1; and

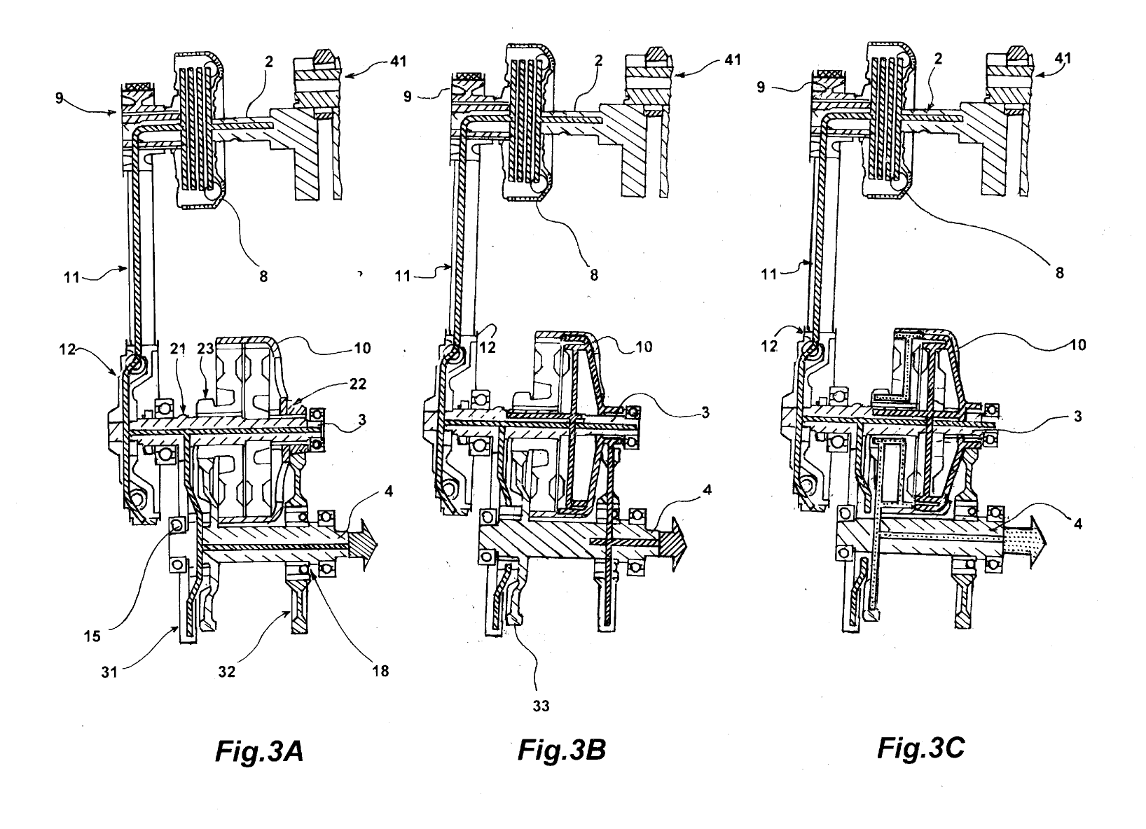

FIGS. 3A, 3B and 3C shows respective longitudinal section view of the synchronous transmission of FIG. 1, and illustrate the transmission of the first, second and third speed, as shown by the figure.

By referring to FIGS. 1 to 3C, a speed transmission with several speeds, in particular three speeds, is designated as a whole with 1. It is of the type suitable to be assembled on a motor vehicle as transmission means which actuates a driving wheel of the motor vehicle, in particular a scooter, that is the (not represented) rear wheel thereof.

To this purpose, it comprises a crankshaft 2, which is made to rotate by the engine, thereof the relative piston rod 40 and crank 41 are represented, and a first driven shaft, that is the primary shaft 3, and a secondary shaft 4, which can be connected directly to the wheel or which transmits the rotation to a (not represented) hub shaft which is connected to the driving wheel of the vehicle. In the first case secondary shaft and hub shaft coincide.

It is to be noted that the arrangement of the shafts is so that the crankshaft 2 assumes a position which is substantially parallel to the rotation axis of the driving wheel, that is the hub shaft. Therefore, this transmission organ has the task of transferring the motion from an engine, which has a crankshaft transversal to the motor vehicle, to a wheel having, too, an axis transversal to the vehicle.

The passage from secondary shaft 4 to a hub can take place through a pair of (not represented) gears having the function of inverting the rotation direction transmitted to the driving wheel, which in this case is simultaneous to the rotation direction of the crankshaft 2, and they insert a fixed reduction ratio onto the hub.

If the hub shaft coincides with the secondary shaft 4, it is necessary that the rotation direction of the crankshaft 2 in the forward gear is opposite to the forward rotation direction of the driving wheel.

In the light of what illustrated above, in any case the secondary shaft 4 is directly or indirectly connected, from the mechanical point of view, to the driving wheel thereto the transmission refers.

The crankshaft 2 and the primary shaft 3 are substantially parallel and they are connected by transmission means allowing to transmit the motion, regardless the different speed ratios. Such transmission means comprises a first pulley 9, mounted on the crankshaft 2, a second pulley 12 mounted on the primary shaft 3, and a transmission belt 11 extending between the two pulleys.

Under transmission belt any flexible annular means is meant apt to transmit the motion between two pulleys offset therebetween, in particular with axes parallel therebetween. The transmission belts then comprise any kind of belts or chains, the pulleys being able to be in case even toothed to implement a synchronous connection.

In the present embodiment example as well as in the subsequent ones, the transmission belts advantageously are synchronous transmission belts; under synchronous belt a belt is meant, usually a toothed belt or a roller chain, transmitting the motion from a wheel o toothed pulley to another wheel or toothed pulley with a transmission ratio which is determined by the ratio between the diameters of the wheels, without it suffers from losses by friction or sliding.

The absence of sliding portions and/or portions dragged by friction, typical instead of the transmissions of CVT (Continuously variable transmission) type, also known as continuous transmissions or continuous variators, makes the herein described speed transmission of synchronous type.

Therefore, in the present embodiment example as well as in the subsequent ones, the above-mentioned pulleys are toothed pulleys, connected by a toothed belt, preferably of the type made of rubber.

On the crankshaft 2 a main clutch 8 is mounted which, in the present example, is of centrifugal type, well known in the art. This clutch type allows transmitting the motion from the crankshaft 2 to the transmission means in cascade, and automatically a rotation regime comprised in a prefixed range is established, for example between 1000 and 2000 revolutions per minute. At a lower rotation regime, the clutch 8 is not engaged and the engine is in neutral, whereas the driving wheel is not stressed.

It is meant, however, that in particular applications, this clutch type can be replaced by a clutch with manual coupling which is perfectly equivalent, or by a clutch actuated by a servomechanism.

In any case, the transmission 1 comprises a driven tract of crankshaft 2 receiving the motion through said main clutch 8, from a driving tract of the crankshaft receiving the motion from the piston.

Three gears are mounted, then a set of three driving gears comprising a first driving gear 21, a second driving gear 22 and a third driving gear 23 are mounted on the primary shaft 3; under driving gear a wheel is meant which receives the motion on the axis thereof and transmits it to a driven wheel mounted on another axis.

Therefore, respective three gears, then a set of three driven gears, comprising a first driven gear 31, a second driven gear 32 and a third driven gear 33, engaged with said first driving gear 21, second driving gear 22 and third driving gear 23, for the transmission of the first, second and third speed, respectively, are mounted on the secondary shaft 4.

The transmission 1 comprises a clutch 10 acting selectively on at least two pairs of gears assigned to the transmission of two of the three speeds.

For reasons of overall dimensions to be minimized, the clutch is arranged on the primary shaft 3, and it acts on the second and on the third driving gear 22, 23 being positioned therebetween. It is to be noted that (FIGS. 3A, 3B and 3C) the third driving gear 23 is positioned between the other two driving gears, that is it is arranged between the first driving gear 21 and the clutch 10. Analogously, the third driven gear 33 is positioned between the other two driven gears, that is it is arranged between the first driven gear 31 and the clutch 10.

The clutch 10 is then capable to act selectively to synchronize two different gears on the same axis; then it comprises a double synchronizer inside a casing 42. Conveniently for greater construction simplicity, each synchronizer comprises a synchronization plate which is activated by automatic synchronizing means, for example centrifugal means, well known in the art, which activate upon reaching a certain rotation regime of the primary shaft 3 which is the same, after deducting possible reduction ratios, between the above-mentioned pulleys, of the crankshaft.

Therefore, a first plate 16 will be activated to synchronize the second driving gear 22, the innermost one in the transmission 1, upon reaching a first predetermined rotation regime; whereas a second plate 17 will be activated to synchronize the third driving gear 23, the one in the intermediate position, upon reaching a second predetermined rotation regime.

At last, the transmission 1 comprises two free wheels arranged at the pairs of gears assigned to the transmission of the first and second speed. In particular a first free wheel 15 is provided, arranged on the secondary shaft 4 at the first driven gear 31, and a second free wheel 18, arranged on the secondary shaft 4 at the second driven gear 32, which is the innermost one with respect to the positioning of the transmission 1.

The operation of the above-described transmission is so schematically summarized: at first the engine runs in neutral and it results to be detached from the transmission thanks to the presence of the main clutch 8 of centrifugal type which, at the minimum revolutions, results to be open.

At a predetermined rpm's (FIG. 3A), the centrifugal clutch 8 closes and through the pulley 9 the motion from the crankshaft 2 is transmitted to the primary shaft 3 of the transmission 1 which is dragged by the second pulley 12; the transmission of the motion takes place through the synchronous belt 11. From the primary shaft 3, the rotation is transmitted to the secondary shaft 4 through the pair of the first driving and driven gears 21, 31.

At a predetermined moment, which is autonomously set by the system the passage from the first to the second speed (FIG. 3B) is requested.

In this case, the first synchronization plate 16 of the clutch 10 intervenes by synchronizing the pair of the second gears 22, 32, by acting on the driving one, whereas the first driven gear 31, which receives the motion from the respective first driving gear 21, rotates idly on the first free wheel 15.

Therefore, since the secondary shaft 4 starts rotating faster than the speed thereat it could rotate if it drove the transmission ratio assigned to the first speed, the gears of the first pair are unconstrained and then excluded from the transmission.

At a predetermined instant, autonomously set in the system, it is requested to pass from the second to the third speed (FIG. 3C).

In this case, the second synchronization plate 17 of the clutch 10 intervenes by synchronizing the pair of the third gears 23, 33, by acting on the driving one, whereas even the second driven gear 32, which receives the motion from the respective second driving gear 22, rotates idly on the second free wheel 18.

Therefore, since the secondary shaft 4 starts rotating faster than the speed thereat it could rotate if it drove the transmission ratio assigned to the second speed, even the gears of the second one are unconstrained and then excluded from the transmission.

In the herein illustrated embodiment examples, both synchronizers 16, 17 are of automatic type, but it is meant that they could be replaced by synchronizers of actuated type, in order to obtain the freedom of being able to impose to the system any transmission ratio by a system with a control logic or in case by the driver.

In the description of the first embodiment example a particular arrangement of the free wheels 15, 18 was considered. However, it is to be meant that one or two of the free wheels could be arranged in case even on the primary shaft 3, associated to the driving gears instead of to the driven ones.

Likewise, even the synchronization could be actuated on the driven wheels instead of on the driving wheels. Conveniently, synchronizers and free wheels find an easier place on different shafts.

To the above-described three-speed synchronous transmission a person skilled in the art, with the purpose of satisfying additional and contingent needs, could introduce several modifications and variants, all however comprised within the protective scope of the present invention, as defined by the enclosed claims.

1. A three-speed motorcycle transmission (1), to be used aboard a motorcycle as transmission means for transmitting motion generated by an engine to a driving wheel, the transmission (1) comprising:
a crankshaft (2), which receives the motion by an engine, having a first pulley (9) mounted thereon;
a primary shaft (3), having a second pulley (12) and a first set of three gears (21, 22, 23) mounted thereon,
a transmission belt (11) connecting said first and said second pulley (9, 12);
a secondary shaft (4), connected to a driving wheel, comprising a second set of three gears (31, 32, 33), engaged in pairs with respective gears (21, 22, 23) of the first set of three gears for the transmission of first, second and third speeds;
a clutch (10) acting selectively on at least two pairs of gears assigned to the transmission of the second and third speeds; and
two free wheels (15, 18) arranged at the pairs of gears assigned to the transmission of the first and second speed.

2. The three-speed transmission (1) according to claim 1, wherein the free wheels (15, 18) are assembled on the primary shaft (3).

3. The three-speed transmission (1) according to claim 1, wherein the transmission belt (11) is a synchronous toothed belt, said pulleys (9, 12) being toothed to implement a synchronous transmission of the motion.

4. The three-speed transmission (1) according to claim 1, wherein the crankshaft (2) comprises a centrifugal clutch (8).

5. The three-speed transmission (1) according to claim 1, wherein the secondary shaft (4) is engaged with a hub shaft, which is connected directly to a driving wheel, by means of a pair of gears determining a reducing ratio.

6. The three-speed transmission (1) according to claim 1, wherein said selective clutch (10) is arranged on the primary shaft (3).

7. The three-speed transmission (1) according to claim 6, wherein said selective clutch (10) is positioned between a second and a third driving gear (22, 23) of said pair of driving wheels, assigned to the transmission of the second and third speeds, and wherein the third driving gear (23) is positioned between the other two driving gears (21, 22), assigned to the transmission of the first and second speed.

8. The three-speed transmission (1) according to claim 7, wherein the third driving gear (23) is arranged between the first driving gear (21), assigned to the transmission of the first speed, and the clutch (10), and analogously the third driven gear (33) arranged between the first driven gear (31) and the clutch (10).

9. The three-speed transmission (1) according to claim 1, wherein said selective clutch (10) comprises a double synchronizer, each synchronizer comprising a synchronization plate (16, 17), which is activated by synchronizing means of centrifugal type, respectively associated to the pairs of gears assigned to the transmission of the second and third speeds.

10. Motorcycle or scooter vehicle including a three speed transmission of claim 1.
